(19) United States
(12) Patent Application Publication
(10) Pub. No.: US 2005/0047137 A1
(43) Pub. Date: Mar. 3, 2005

(54) Cross-shaped laser rays generator with non-spherical lens

(75) Inventor: Chih-Hsiung Lin, Sindian City (TW)

Correspondence Address: BRUCE H. TROXELL;SUITE 1404, 5205 LEESBURG PIKE, SUITE 1404, FALLS CHURCH, VA, 22041, US

(73) Assignee: ERA OPTOELECTRONICS INC.

(21) Appl. No.: 10/649,813

(22) Filed: Aug. 28, 2003

(51) Int. Cl. F21K 2/00

(52) U.S. Cl. 362/259

(57) ABSTRACT

A cross-shaped laser rays generator with a non-spherical lens allows diverging laser rays emitted by a laser source to become parallel beams via being refracted by a collimator lens element and to form two orthogonal and cross-shaped laser rays via being refracted by a non-spherical lens element. Further, part of the parallel beams can pass through an undeviating rays area of the non-spherical lens element to project to the intersection point of the cross-shaped laser rays so that the cross-shaped laser rays can have a brighter central point for projecting farther distance and being recognized more easily.

### BACKGROUND OF THE INVENTION

1. Field of the Invention

The present invention relates to a laser rays generator and particularly to a cross-shaped laser rays generator with lens thereof.

2. Description of Related Art

The visible light semiconductor laser technique has been getting mature with decreasing price in recent years so that products provided with the visible light semiconductor laser are getting popular. Especially, the laser pointer, which is one of the products provided with the visible light semiconductor laser, has advantages such as being easy to be carried about and convenient to be used so that it is widely utilized in a speech, a brief report and a teaching. Further, a kind of laser pointer can produce cross-shaped light track to project to the surface of an object directly and display horizontal and vertical lines for facilitating works of the builder and the upholsterer.

U.S. Pat. No. 6,069,748 discloses a laser rays generator system, which includes lens disposed in front of a laser source emitting diverging laser beams, and the lens at a cross section thereof is provided with negative optical power and at another cross section thereof is provided with positive optical power. In this way, the diverging laser beams can be refracted with the lens to produce laser rays projecting on an object.

The present inventor has filed a patent application in U.S., application Ser. No. 10/142,845, and in China, Publication No. CN1375724A, entitled CROSS-SHAPED BEAM LASER RAY DEVICE AND LENS, which discloses the lens are crisscross cylindrical lens composed of the cross over part of two intersecting cylindrical lens with equal diameters. The diverging laser beams from the laser source can be focused with a convex lens and refracted by the crisscross cylindrical lens to produce cross-shaped beams.

The diverging laser beams emitted from the laser source in the preceding U.S. Pat. No. 6,069,748 have different measures at the two orthogonal cross sections so that the laser ray generator is incapable of producing cross-shaped laser rays equivalent in length and brightness.

Although the crisscross cylindrical lens in U.S. patent application Ser. No. 10/142,845 can produce cross-shaped laser rays equivalent in length and brightness, it is not possible to increase or decrease the projection angle of the cross-shaped laser rays according to the user' need under the condition of providing the same laser source so that the projection distance is achieved by way of increasing brightness thereof. Alternatively, the central point of the cross-shaped laser rays is brightened to allow the central point being capable of projecting farther and being recognized more easily.

### SUMMARY OF THE INVENTION

Accordingly, an object of the present invention is to provide a laser rays generator and various non-spherical lens thereof to produce cross-shaped laser light tracks in different lengths and brightness and more bright central points so as to meet different necessities of the users.

### BRIEF DESCRIPTION OF THE DRAWINGS

The present invention can be more fully understood by reference to the following description and accompanying drawing, in which:

FIG. 1 is a perspective view of a laser beam generator according to the present invention in the first embodiment thereof;

FIG. 2 is a cross section of non-spherical lens unit shown in FIG. 1;

FIG. 3 is another cross section of non-spherical lens unit shown in FIG. 1;

FIG. 4 is a cross section of non-spherical lens unit in the second embodiment of the present invention;

FIG. 5 is a perspective view of a laser beam generator according to the present invention in the third embodiment thereof;

FIG. 6 is a cross section of non-spherical lens unit shown in FIG. 5;

FIG. 7 is a perspective view of a laser beam generator according to the present invention in the fourth embodiment thereof;

FIG. 8 is a cross section of non-spherical lens unit shown in FIG. 7;

FIG. 9 is a perspective view of a laser beam generator according to the present invention in the fifth embodiment thereof;

FIG. 10 is a cross section of non-spherical lens unit shown in FIG. 9;

FIG. 11 is another cross section of non-spherical lens unit shown in FIG. 9;

FIG. 12 is a cross section of non-spherical lens unit in the sixth embodiment of the present invention;

FIG. 13 is a cross section of non-spherical lens unit in the seventh embodiment of the present invention;

FIG. 14 is a perspective view of a non-spherical lens unit in the eighth embodiment of the present invention; and

FIG. 15 is a perspective view of a non-spherical lens unit in the ninth embodiment of the present invention.

### DETAILED DESCRIPTION OF THE PREFERRED EMBODIMENTS

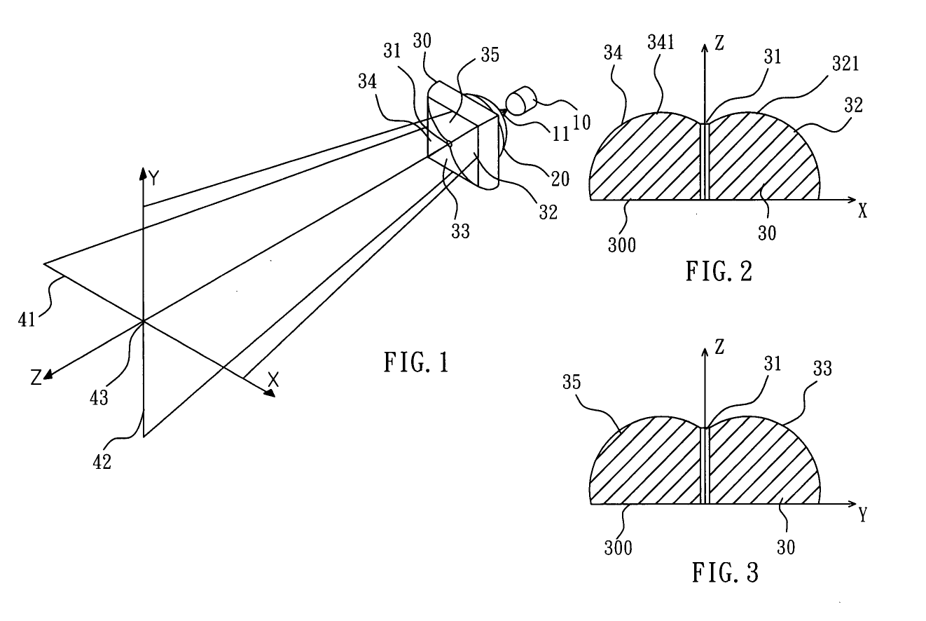

Referring to FIG. 1, a cross-shaped laser beam generator of the present invention in the first embodiment thereof includes a laser source 10, a collimator lens element 20 for producing parallel beams and a non-spherical lens element 30. The laser source 10 is capable of emitting diverging laser rays 11. The collimator lens element 20 is disposed at an emit end of the laser source 10. The non-spherical lens element 30 is disposed at a refractive emit end of the collimator lens element 30. The diverging laser ray 11 is refracted via the collimator lens element 20 and changed to parallel beams projecting toward a side of the non-spherical lens element 30 such that the parallel beams can be refracted by the non-spherical lens element 30 and two mutually perpendicular laser rays 41, 42, which form a shape of cross, are produced to emit from the other side of the non-spherical lens element 30. Further, part of the parallel beams pass through a central through hole 31, which communicates both sides of the non-spherical lens element 30, to project toward an intersection 43 of the two laser rays 41, 42 so as to brighten the intersection 43.

Referring to FIGS. 2 and 3 in company with FIG. 1, the non-spherical lens element 30 shown in the first embodiment has a flat surface 300 at the side facing the collimator lens element 20 and the other side of the non-spherical lens element 30 opposite to the flat surface 300 includes a first curved surface 32, a second curved surface 33, a third curved surface 34 and a fourth curved surface 35. The first curved surface 32 and the third curved surface 34 are opposite to each other and the second curved surface 33 is opposite to the fourth curved surface 35. It can be seen in FIG. 2 that the cross section of the non-spherical along an X-Z plane, which transverses the central through hole 31, shows two partial cylindrical surfaces connecting with each other being formed by the first curved surface 32, the third curved surface 34 and the flat plane 300. The first curved surface 32 and the third curved surface 34 bend toward two lateral sides from the highest spots 321, 341 thereof with respect to the flat plane 300. The central through hole 31 is disposed below the highest spots 321, 341. It can be seen in FIG. 3 that another cross section along a Y-Z plane, which transverses the central through hole 31, to illustrate two continuous cylindrical surfaces being formed by the second curved surface 33, the fourth curved 35 and the flat plane 300.

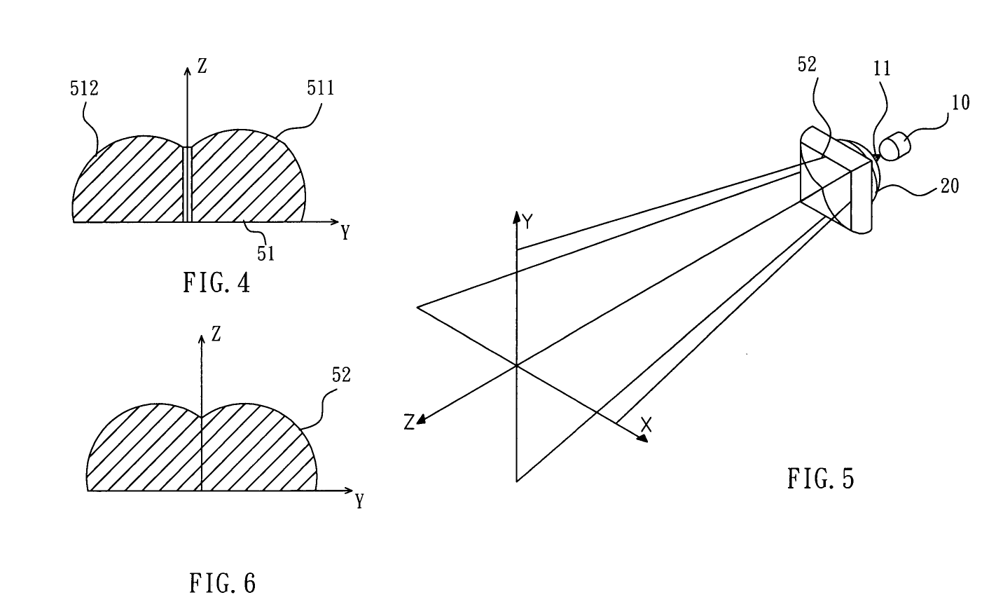

Referring to FIG. 4, the second embodiment of the present invention is illustrated to provide a non-spherical lens element 51 with the two opposite curved surfaces 511, 512 thereof being disposed non-symmetrically. The curved surface 511 has a radius of curvature longer than that of the curved surface 512 such that longer laser rays can be refracted. Therefore, cross-shaped laser rays with different lengths and illuminations can be refracted by way of designing different curved surfaces.

Referring to FIGS. 5 and 6, the third embodiment of the present invention is illustrated to provide a non-spherical lens element 52, which has the configuration thereof being almost the same as the non-spherical lens element 30 shown in FIG. 1 except the central through hole being not arranged. The cross-shaped laser rays produced with the third embodiment can be refracted with less bright light point.

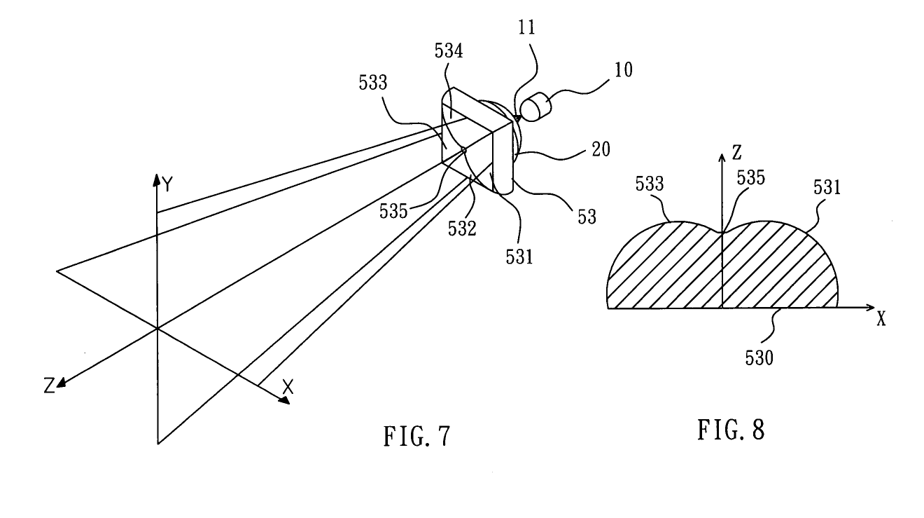

Referring to FIGS. 7 and 8, the fourth embodiment of the present invention is illustrated to provide a non-spherical lens element 53, which has the concave intersection of the four curved surfaces 531, 532, 533, 534 being flattened and a little flat surface 535 being parallel with the flat surface 530 at the opposite side. The rest part of the non-spherical lens element 53 is the same as the non-spherical lens element 52 shown in FIG. 5 so that the cross-shaped laser rays can be emitted. Because part of the parallel beams passes through the little flat surface 535 directly without being refracted, the intersection of the cross shape has more bright light point.

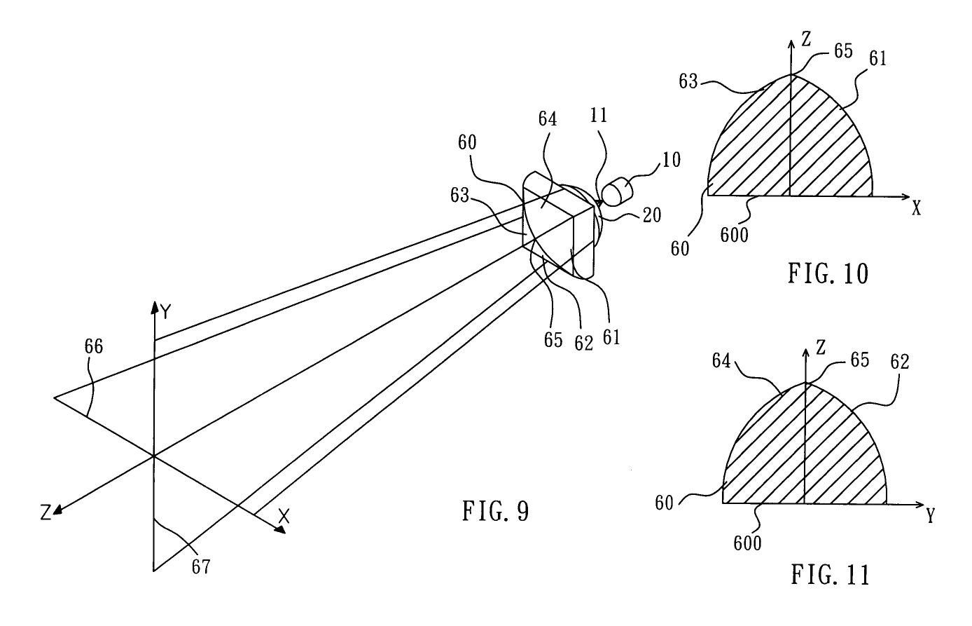

Referring to FIGS. 9, 10 and 11, the fifth embodiment of the present invention provides a non-spherical lens element 60 has four curved surfaces 61, 62, 63 and 64 as the non-spherical lens element 52 shown in FIG. 5 does. But, the four curved surfaces 61, 62, 63 and 64 has an intersection 65 being disposed corresponding to the uppermost spot of the flat surface 600 at the opposite side. The four curved surfaces 61, 62, 63 and 64 has longer radius of curvature thereof than the four curved surfaces of the non-spherical lens element 52 so that it is possible for the non-spherical lens element 60 refracts two longer cross-shaped laser rays 66, 67 with less brightness.

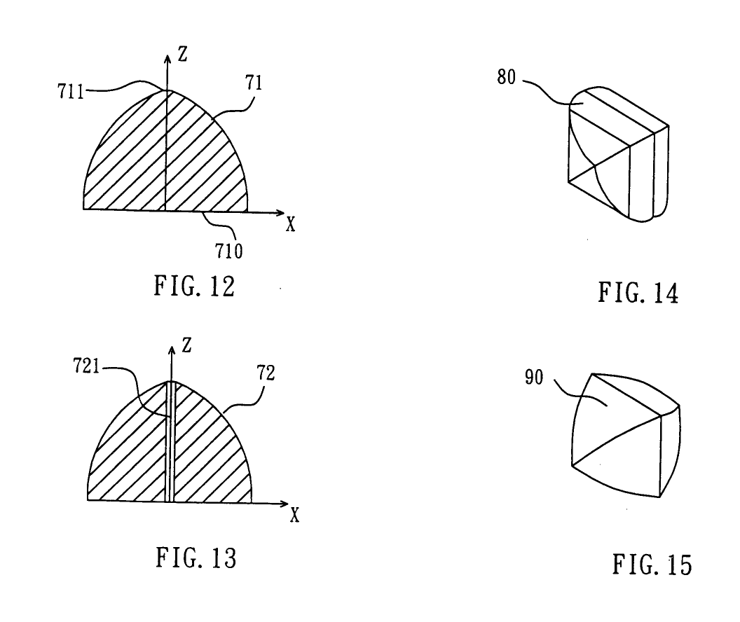

Referring to FIG. 12, the sixth embodiment of the present invention provides a non-spherical lens element 71, which has a configuration almost the same as the non-spherical lens element 60 shown in FIG. 9 except a flattened intersection 65 having a little flat surface 711 parallel with a flat surface 710 at the opposite side.

Referring to FIG. 13, the seventh embodiment of the present invention provides a non-spherical lens element 72, which has a configuration almost the same as the non-spherical lens element 71 shown in FIG. 12 except a central through hole 721 being arranged instead of the little flat surface 711.

The non-spherical lens elements 71, 72 shown in FIGS. 12 and 13 are capable of emitting cross-shaped laser rays with more bright light points at the intersections thereof.

Referring to FIG. 14, the eighth embodiment of the present invention provides that a non-spherical lens element 80 at two sides thereof has four curved surfaces respectively, which are the same as the four curved surfaces of the non-spherical lens element 52 shown in FIG. 5. Further, the two sides are designed to be symmetrical to each other so that the cross-shaped laser rays can be refracted.

Referring to FIG. 15, the ninth embodiment of the present invention provides that a non-spherical lens element 90 at two sides thereof has four curved surfaces respectively, which are the same as the four curved surfaces of the non-spherical lens element 60 shown in FIG. 9. Further, the two sides are designed to be symmetrical to each other so that the cross-shaped laser rays can be refracted.

The non-spherical lens elements 80, 90 each at the intersections of the curved surfaces can be arranged to have a through hole or a flattened part such that an undeviating area can be formed and the intersection of the refracted cross-shaped rays is a brighter light point.

It is appreciated that the laser ray generator according the present invention with various non-spherical lens element can produce cross-shaped laser rays with different lengths and brightness and can provide a brighter central point.

While the invention has been described with reference to preferred embodiments thereof, it is to be understood that modifications or variations may be easily made without departing from the spirit of this invention, which is defined by the appended claims.

1. A cross-shaped laser rays generator, comprising:
a laser source, providing an emitting end and being capable of emitting laser rays;
a collimator lens element, providing a reflection emitting end and being disposed at the emitting end of the laser source; and
a non-spherical lens element, being disposed at the reflection emitting end of the collimator lens element, at a side thereof including a first curved surface, a second curved surface, a third curved surface and a fourth curved surface with the first curved surface being opposite to the third curved surface and the second curved surface being opposite to the fourth curved surface, the first and the third curved surfaces connecting with the second and the fourth curved surfaces with an undeviating laser rays area formed at an intersection of the four curved surfaces;
whereby, diverging laser rays emitted from the laser source project to the collimator lens element and are refracted via the collimator lens element to become parallel beams projecting to the non-spherical lens element and then the parallel beams are refracted as two orthogonal laser rays via the non-spherical lens element with part of the parallel beams piercing the undeviating laser ray area and projecting to an intersection point of the two orthogonal laser rays such that the intersection point is provided with a brighter light point.

2. The cross-shaped laser rays generator according to claim 1, wherein the undeviating laser rays area is at an uppermost spot of the curved surfaces.

3. The cross-shaped laser rays generator according to claim 1, wherein the undeviating laser rays area is disposed below an uppermost spot of the curved surfaces.

4. The cross-shaped laser rays generator according to claim 1, wherein the undeviating laser rays area is a through hole communicating with two sides of the non-spherical lens element.

5. The cross-shaped laser rays generator according to claim 1, wherein the undeviating laser rays area is a flat surface respectively parallel disposed at two sides of the non-spherical lens element.

6. The cross-shaped laser rays generator according to claim 1, wherein the non-spherical lens element at another side thereof is provided with a shape of plane.

7. The cross-shaped laser rays generator according to claim 1, wherein the two sides of the non-spherical lens element are symmetrical to each other.

8. A cross-shaped laser rays generator, comprising:
a laser source, providing an emitting end and being capable of emitting laser rays;
a collimator lens element, providing a reflection emitting end and being disposed at the emitting end of the laser source; and
a non-spherical lens element, being disposed at the reflection emitting end of the collimator lens element, at a side thereof including a first curved surface, a second curved surface, a third curved surface and a fourth curved surface with the first curved surface being opposite to the third curved surface and the second curved surface being opposite to the fourth curved surface, the first and the third curved surfaces connecting with the second and the fourth curved surfaces with the curved surfaces bending toward two lateral sides from an uppermost spot thereof respectively and an intersection of the four curved surfaces being below the uppermost spots;
whereby, diverging laser rays emitted from the laser source project to the collimator lens element and are refracted via the collimator lens element to become parallel beams projecting to the non-spherical lens element and then the parallel beams are refracted as two orthogonal laser rays via the non-spherical lens element.

9. A non-spherical lens element, being used for allowing parallel beams being refracted as two orthogonal and cross-shaped laser rays, comprising
a side, having a first curved surface, a second curved surface, a third curved surface and a fourth curved surface with the first curved surface being opposite to the third curved surface and the second curved surface being opposite to the fourth curved surface, the first and the third curved surfaces connecting with the second and the fourth curved surfaces with an undeviating laser ray area formed at an intersection of the four curved surfaces;
whereby, parallel beams can be refracted as two orthogonal and cross-shaped laser rays via the non-spherical lens element with part of the parallel beams piercing the undeviating laser ray area and projecting to an intersection point of the two orthogonal laser rays such that the intersection point is provided with a brighter light point.

10. The non-spherical lens element according to claim 9, wherein the undeviating laser rays area is at an uppermost spot of the curved surfaces.

11. The non-spherical lens element according to claim 9, wherein the undeviating laser rays area is disposed below the uppermost spot of the curved surfaces.

12. The non-spherical lens element according to claim 9, wherein the undeviating laser rays area is a through hole communicating with two sides of the non-spherical lens element.

13. The non-spherical lens element according to claim 9, wherein the undeviating laser rays area is a flat surfaces respectively parallel disposed at two sides of the non-spherical lens element.

14. The non-spherical lens element according to claim 9, wherein the non-spherical lens element at another side thereof is provided with a shape of plane.

15. The non-spherical lens element according to claim 9, the two sides of the non-spherical lens element are symmetrical to each other.

16. A non-spherical lens element, being used for allowing parallel beams being refracted as two orthogonal and cross-shaped laser rays, comprising
a side, having a first curved surface, a second curved surface, a third curved surface and a fourth curved surface with the first curved surface being opposite to the third curved surface and the second curved surface being opposite to the fourth curved surface, the first and the third curved surfaces connecting with the second and the fourth curved surfaces with the curved surfaces bending toward two lateral sides from an uppermost spot thereof respectively and an intersection of the curved surfaces being disposed below the uppermost spots;
whereby, parallel beams can be refracted as two orthogonal and cross-shaped laser rays via the non-spherical lens element.
